(19) United States
(12) Patent Application Publication
(10) Pub. No.: US 2013/0096473 A1
(43) Pub. Date: Apr. 18, 2013

(54) TRAINING COMPLEX "BAROTUB" AND METHODS OF OPTIMIZATION, EXCESSIVE STRESS PREVENTION AND TRAINING OF THE PSYCO-PHYSIOLOGICAL STATE OF A PERSON

(71) Applicant: Oleg Berezhov, Moscow (RU)

(72) Inventor: Oleg Berezhov, Moscow (RU)

(21) Appl. No.: 13/274,376

(22) Filed: Oct. 17, 2011

(51) Int. Cl. A61H 9/00

(52) U.S. Cl. 601/148

(57) ABSTRACT

The invention improves existing training complexes intended for training skills of relaxation and activation of psycho-physiological processes. The proposed training complex consists of: a) Training apparatus BAROTUB which includes the immersion tub that creates the effect of partial weightlessness, the system of changing air pressure inside the BAROTUB, audio-video system, aromatherapy/oxygen system, dry massage system, training complex control system; b) Methods and programs for training the skills of relaxation and activation of psycho-physiological processes as well as methods of excessive stress prevention.

### BRIEF DESCRIPTION OF THE INVENTION

The invention improves existing training complexes intended for training skills of relaxation and activation of psycho-physiological processes. The proposed training complex consists of: a) Training apparatus BAROTUB which includes the immersion Tub that creates the effect of partial weightlessness, the system of changing air pressure inside the BAROTUB, audio-video system, aromatherapy/oxygen system, dry massage system, training complex Control System; b) Methods and programs for training the skills of relaxation and activation of psycho-physiological processes as well as methods of excessive stress prevention.

These and other features, aspects, and advantages of the present invention will become apparent from a reading of the detailed description of the preferred embodiments of the invention (including the subjoined claims) and by reference to the attached drawings.

### BRIEF DESCRIPTION OF THE DRAWINGS

FIG. 1 shows the training complex BAROTUB—isometric view.

FIG. 2—same, side view.

FIG. 3—same, rear view.

FIG. 4—same, top view.

FIG. 5—same, bottom view.

FIG. 6—same, side view with removed Body.

FIG. 7—same, front with removed Body.

FIG. 8—same, rear view with removed Body.

FIG. 9—same, isometric view with removed Body.

FIG. 10—same, cross-section A-A in FIG. 4.

FIG. 11—same, isometric view with raised Cover Lid and without the Elastic Blanket.

FIG. 12—hydraulic circuit.

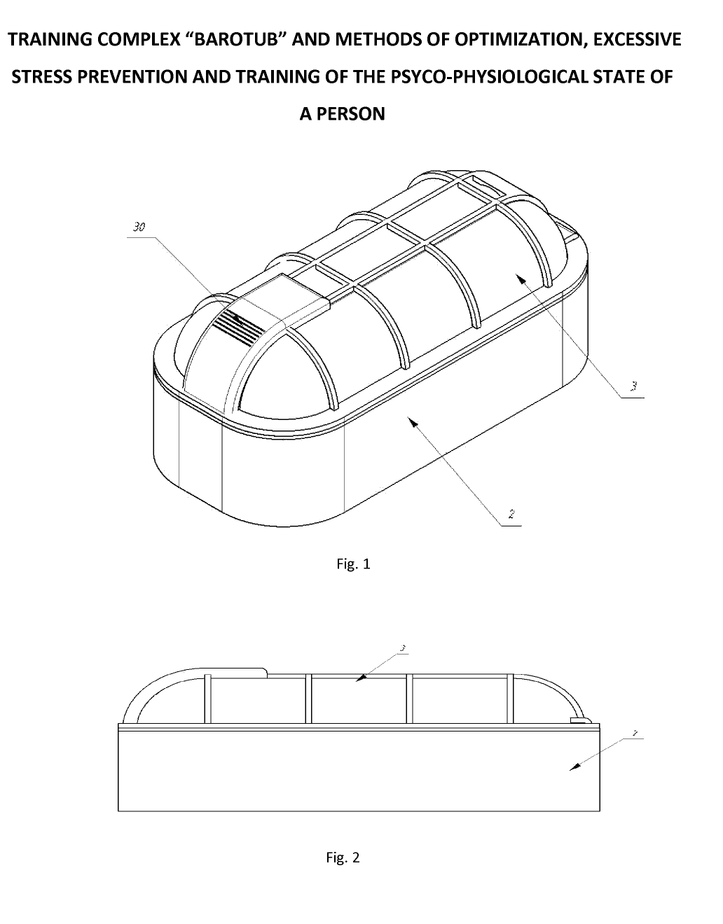

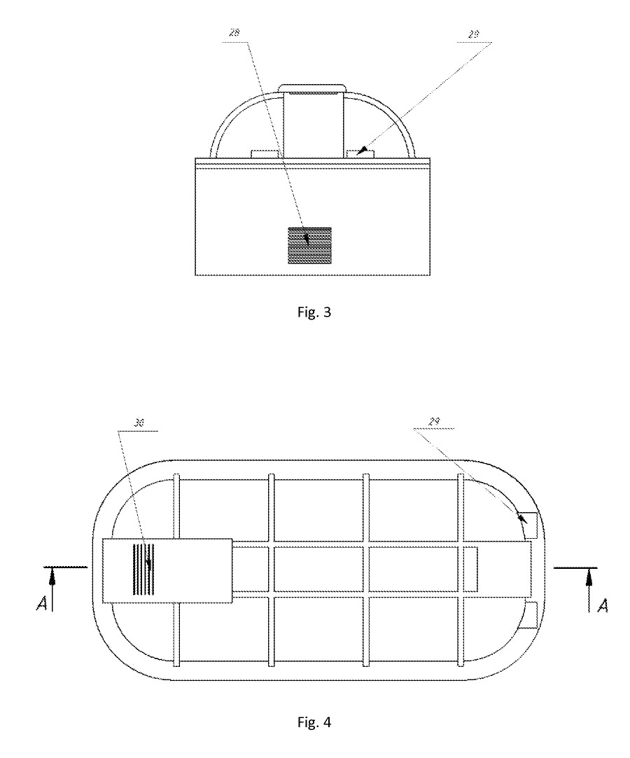

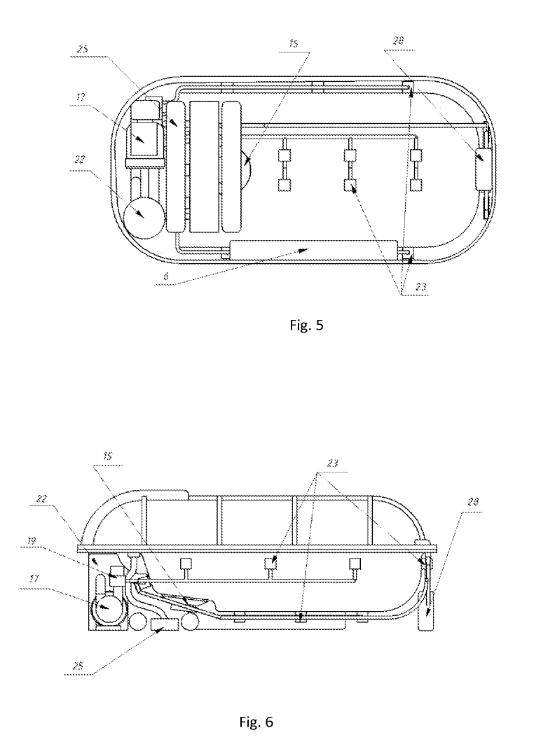

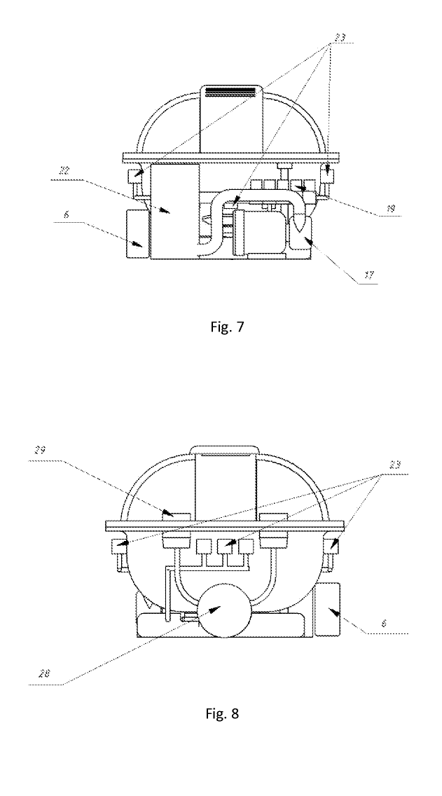

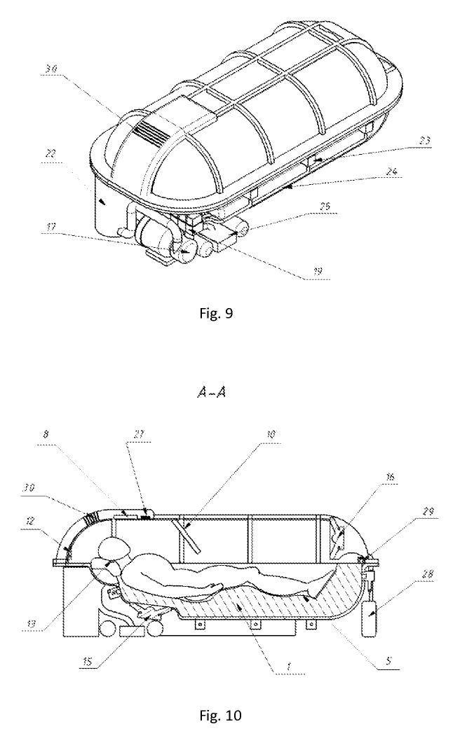

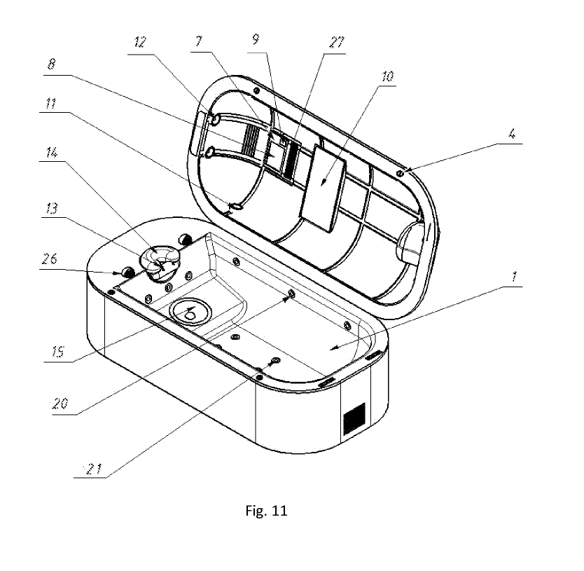

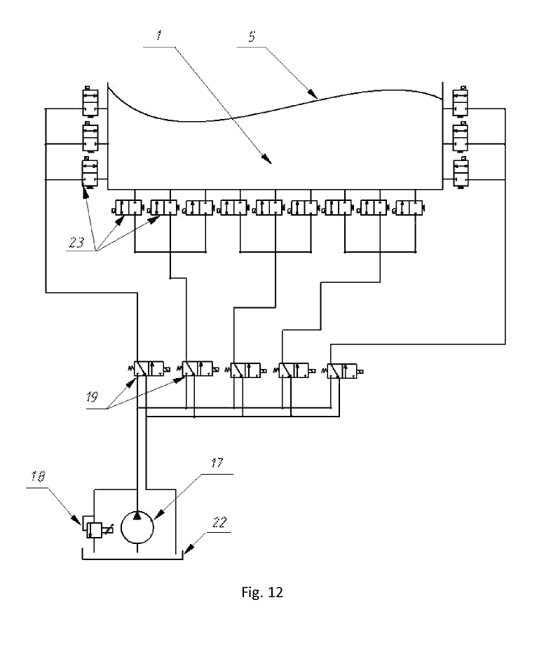

### DETAILED DESCRIPTION OF THE INVENTION

The invention relates to training devices and methods for learning skills of optimization of psycho-physiological state of a person, training skills of relaxation and activation of psycho-physiological processes as well as prophylactic procedures of excessive stress prevention.

The present invention improves existing training complexes intended for training skills of relaxation and activation of psycho-physiological processes in the following areas: a) Improved effectiveness of the method of optimization of the psycho-physiological state of a person; b) Expansion of versatility as well as improved safety and reliability of the training complex BAROTUB designed to train the skills of relaxation and/or activation of psycho-physiological processes. The above is achieved through the following:

(1) The proposed training complex BAROTUB which includes: a) Immersion Tub that creates the effect of partial weightlessness. It contains an Elastic Blanket that is tightly sealing the Tub along its perimeter. The Tub is supplied with the system of heating the water and letting water in and out. It is controlled by the main Control System of the training complex through the main control panel; b) The immersion Tub is equipped with the Cover Lid that is tightly sealed along the perimeter of the Tub and the system of regulation of air pressure under the Cover Lid; c) Control System of the training complex BAROTUB which includes Control System of the physical condition of a person; d) Audio-video system connected with the main Control System. Audio system is equipped with a woofer, located either at the bottom of the Tub and/or on the Tub Cover Lid; e) Special audio system utilizing bone conducting speakers; f) Nozzles for dry hydro massage; g) Aromatherapy/Oxygen system.

(2) The method of optimization of training and preventive maintenance of psycho-physiological state of a person that includes the following: a) Preliminary diagnostics of the physical condition of a person and then a person is given an individual program of training taking into account his physiological parameters; b) Water of comfortable temperature is let in under the Elastic Blanket and the person is placed on the Elastic Blanket inside the training apparatus BAROTUB; c) The effect of the state of partial weightlessness is combined with the variable air pressure inside the BAROTUB according to the individual training program; d) Auditory stimulation is given during a set time together with a constant control of the physical condition. During auditory stimulation the additional sound stimulation on the organism is conducted with the use of the bone conduction speakers. Specific low frequency sounds are utilized in individual programs. They get transmitted through the water and/or air; e) Stimulation of visual organs and/or olfactory organs; f) Dry hydro massage; g) Aroma/Oxygen therapy.

Training complex BAROTUB includes Tub 1 (immersion Tub) with the Body 2. On the Body 2 there is the swinging Cover Lid 3 that sits tightly along the upper perimeter of the Tub 1 with the Locking Mechanism 4. Tub 1 contains the Elastic Blanket 5 fixed to its upper edge. It does not pass water and is positioned in such way in the Tub 1 filled with water, so that a condition of partial weightlessness (“dry” immersion) is simulated for a person placed on the Elastic Blanket 5. Control System 6 of the training complex BAROTUB may be located on the Body 2 and includes the following components: control panel 7, touch screen 8, the control subsystem 9 of the physical condition of a person, video system control mechanism 10, the audio system with side stereo speakers 11, rear speaker 12, bone conduction speakers 13 located on the headrest 14, the woofer 15 located on the bottom of the Tub 1, and the woofer 16 located on the inner surface of the Cover Lid 3, water delivery, heating and draining system, air supply and removal system. Water delivery, heating and draining system includes the circulation pump 17 with a safety valve 18, associated with hydraulic valves 19, intended to supply water to the nozzles 20 of filling the Tub 1 and the water supply to the injectors 21 of dry massage system, with heater tank 22, valves 23 and also drain and overflow water pipes 24. The system of air supply and removal includes oxygen equipment 25 associated with the nozzles 26 for the supply of oxygen under the Cover Lid 3, the nozzle 27 for feeding aromas, exhaust compressor 28 with the exhaust pipes 29 and 30 for extraction of aromas. BAROTUB includes the system of increasing and reducing air pressure through supply and removal of the air under the Cover Lid 3.

Training complex BAROTUB is used in fitness salons, fitness clubs, spas and relaxation centers. Control System 6 is configured to work in different modes: physical relaxation, mental relaxation, revitalization of physical activity, increased brain activity, excessive stress prevention and others. For each of these states an individual training program provides specific audio frequency sound, a certain rhythm sound, specific video sequences, specific composition of air and water temperature in the Tub 1 (immersion Tub), specific high or low pressure under the Cover Lid 3.

Before training is conducted a preliminary diagnosis of the physical state of a client is determined by measuring the basic physiological parameters such as blood pressure, pulse rate, and others. After interview with the trainer the client is given an individual training program taking into account his/her physiological parameters. The measured parameters are entered into the memory of the Control System 9 of the physical condition of the subject. Optimal individual training program includes the specific combination of parameters determined for each of the audio, visual, olfactory and variable air pressure systems together with the state of partial weightlessness.

The sound system provides differentiated effect on the subject. Audio system is configured such that low frequency sounds are produced by woofers 15 and 16 located in the water and air accordingly, rear speaker 12 produce the sounds of medium frequencies, and the sounds of higher frequencies are reproduced by the stereo speakers 11, the bone conduction speakers 13 are located on headrest 14 and are positioned to be as close as possible to the bones of the human skull during the training. Bone conduction speakers 13 play sounds that to create a particular rhythm of life, such as relaxation or activation of life processes, depending on the selected training program. If necessary, additional aromatherapy program is included in combination with the increased or decreased amount of oxygen in the air mixture supplied to the client.

Training is carried out under the constant control of the physical and physiological condition of the visitor. The client is subjected to a specified time period to the sounds from the side stereo speakers 11, rear speaker 12 and woofers 15 and 16 of the audio system in conjunction with the additional sound from the bone conduction speaker 13. All sounds are comfortable to the human ear. The audio series is chosen to activate those areas of the brain and the organs of the human body that are “responsible” for the specific condition of the body defined in the training program. Low bass frequencies (about 10 Hz to 80 Hz) determine sound richness and depth and affect mainly the body. They are particularly effective when played through the speaker 15 because water conducts low frequencies sound particular well. The upper basses (80 Hz to 200 Hz) are those sounds that “make” people dance. They are particularly effective in the training programs aimed at activation of human abilities and psycho-physiological states. Frequencies from 200 Hz to 2000 Hz are the frequencies of most musical instruments. They are very comfortable for the human ear when the proper volume is selected. The upper zone of mid-range sounds (from 2000 Hz to 4000 Hz) when in a low volume emphasize human speech, supplement and nourish it. Frequencies from 4000 Hz to 6000 Hz produce an effect of the presence or distance of the sound. A careful use of sounds with frequencies from 6000 Hz to 16000 Hz makes it possible to vary the ease of music comprehension. The correct choice of ratios of low frequencies, medium frequencies and high frequencies sounds is an important part of the training program.

During the training of the client a certain water temperature is selected in the Tub 1 (immersion Tub) and the subject is put on the Elastic Blanket 5 that separates the person from water. The person appears to be freely “suspended” in water and the pressure rendered on various parts of a body is counterbalanced. The effects of gravity are reduced, the tone and power qualities of extensor muscles go down, the activity of motor control mechanisms and the activity of the basic muscular proprioceptive system goes down. The volume of liquid released from the organism increases, the muscle tone decreases and heart works half as hard. These almost perfect conditions for relaxation trainings allow the unexpected effect when the pressure is changing under the Cover Lid 3.

Using the effect of a “hypobaric pressure chamber”, i.e. the reduced pressure in this case enhances the relaxation effect and allows the maximum relaxation of the body. The effect of a “hyperbaric pressure chambers”, i.e., increased pressure under the Cover Lid 3 in conjunction with the state of “partial weightlessness” in the Tub 1 promotes activation of body defenses.

Conduction of body massage during the training, carried out by upward directed toward the Elastic Blanket 5 jets of water produced by nozzles 21, can either strengthen the effect of relaxation training, or contribute to activation of the body depending on the pace and strength of impacting the body water.

All trainings are accompanied by the selected sound effects program through the audio system. Video system 10 with a touch screen located on the inside of the Cover Lid 3 in the area of good visibility to the client reinforces the effect of training by a specially selected video program. Due to the ability of the cardiovascular system of a human to adjust to the rhythms defined in the individual program there is a gradual normalization of pulse and pressure of the client. In accordance with the training program a mixture of air with high or low oxygen content and natural smell flavors are supplied under the Cover Lid 3 through the Control System 6.

During the training the constant communication with the client is maintained and the client can independently change the conditions of the training using the touch screen 8 of Control System 6. During the training session the Control System 9 of the physiological state of the client is continually monitoring the state of the client. It is equipped with the safety mechanism of instantly turning off all equipment when necessary, gently opening the Cover Lid 3 and bringing inside to atmospheric pressure.

The efficiency of the above method of optimization of psycho-physiological state of a person can be increased by using special breathing practices (e.g. holotropic breathing) as well as utilizing static and dynamic meditation. The client can to choose the opportunity to include into the training program such additional exercises that intensify production in the body of important hormones like endorphins as well as corticosteroids that have anti-inflammatory function.

Combined use of the above methods in training clients, e.g. the state of partial weightlessness in the Tub 1 (immersion Tub) in combination with high or low air pressure under the Cover Lid 3 provides a synergistic effect and allows to achieve stable positive results in the psycho-physiological condition of the person.

The training complex BAROTUB is designed to provide a high level of safety to a client. Control System 9 monitors condition of the client and can safely shut down the training complex any time the undesirable physiological parameters of the client get into a dangerous zone.

The achievements that have been reached as results of this invention are the following: (1) The expansion of universality of the training complex designed to train the skills of relaxation and/or activation of psycho-physiological processes; (2) Increased efficiency of optimization of psycho-physiological condition of the person; (3) Increased reliability and safety.

1. Method of optimization, excessive stress prevention and training of psycho-physiological state of the person, which includes the following: a) preliminary diagnosis of the physical condition of a person; b) a person is given the individual program of training taking into account his/her physiological parameters c) auditory stimulation is conducted during a set time together with the constant control of the physical condition; d) Water of comfortable temperature is let in under the Elastic Blanket of the training apparatus BAROTUB and the person is placed on the Elastic Blanket inside the BAROTUB; e) The person is subjected to the effects of the simulated partial weightlessness combined with the gradual change of the air pressure inside the BAROTUB.

2. Method of optimization, excessive stress prevention and training of psycho-physiological state of the person as described in item 1 and is different in that during auditory stimulation additional sound stimulation using bone conduction speakers is conducted.

3. Method of optimization, excessive stress prevention and training of psycho-physiological state of the person as described in item 1 and is different in that auditory stimulation is conducted by differentially spaced speakers of low, mid and high frequencies.

4. Method of optimization, excessive stress prevention and training of psycho-physiological state of the person as described in item 1 and is different in that it is conducted in combination with the stimulation of visual organs and/or olfactory organs.

5. Method of optimization, excessive stress prevention and training of psycho-physiological state of the person as described in item 1 and is different in that the gradual change of air pressure in the BAROTUB is increased or reduced in accordance with the individual training program.

6. Method of optimization, excessive stress prevention and training of psycho-physiological state of the person as described in item 1 and is different in that the low frequency sound stimulation is conducted through water and/or air.

7. Method of optimization, excessive stress prevention and training of psycho-physiological state of the person as described in item 1 and is different in that an individual training program includes dry hydro massage.

8. Training complex BAROTUB which includes an immersion Tub that creates the effect of partial weightlessness. It contains an Elastic Blanket that is tightly sealing the Tub along its perimeter. The Tub is supplied with the system of heating the water and letting water in and out. It is controlled by the main Control System of the training complex which includes control panel and system of the physical condition of the person. The immersion Tub is equipped with the Cover Lid that is tightly sealed along the perimeter of the Tub, as well as with the system of regulation of air pressure inside the Tub. Also there is an audio system.

9. Training complex BAROTUB as described in item 8 and is different in that it is equipped with an additional audio system that utilizes bone conduction speaker.

10. Training complex BAROTUB as described in item 8 and is different in that it is equipped with water injectors for dry hydro massage.

11. Training complex BAROTUB as described in item 8 and is different in that there is audio-video system connected with the main Control System under the Cover Lid of the BAROTUB.

12. Training complex BAROTUB as described in item 8 and is different in that the audio system is equipped with woofers located at the bottom of the tub and/or in the Cover Lid.

13. Training complex BAROTUB as described in item 8 and is different in that it includes aromatherapy system.
